(19) United States
(12) Patent Application Publication
(10) Pub. No.: US 2026/0299460 A1
(43) Pub. Date: Oct. 1, 2026

(54) DEVELOPING DEVICE AND IMAGE FORMING APPARATUS

(71) Applicant: FUJIFILM Business Innovation Corp., Tokyo (JP)

(72) Inventors: Hirokazu MUKAI, Kanagawa (JP); Shigeru INABA, Kanagawa (JP)

(73) Assignee: FUJIFILM Business Innovation Corp., Tokyo (JP)

(21) Appl. No.: 19/264,886

(22) Filed: Jul. 10, 2025

(30) Foreign Application Priority Data
Mar. 25, 2025 (JP) 2025-050527

(51) Int. Cl. G03G 15/08; G03G 15/01

(52) U.S. Cl. CPC G03G 15/0812; G03G 15/0121; G03G 15/0189; G03G 15/0808

(57) ABSTRACT

A developing device includes a first developer holding unit that is disposed to face an image holding unit, holds a developer on a surface thereof, and rotates to develop a latent image of the image holding unit, a second developer holding unit that is disposed downstream of the first developer holding unit in a rotation direction of the image holding unit, holds a developer on a surface thereof, and rotates to develop a latent image of the image holding unit, and a regulating unit that is disposed in a region in which the first developer holding unit and the second developer holding unit face each other and the developer is transferred from the first developer holding unit to the second developer holding unit and regulates a layer thickness of the developer held by the second developer holding unit, in which a closest distance between the regulating unit and the second developer holding unit is shorter than a closest distance between the regulating unit and the first developer holding unit.

### CROSS-REFERENCE TO RELATED APPLICATIONS

This application is based on and claims priority under 35 USC 119 from Japanese Patent Application No. 2025-050527 file Mar. 25, 2025.

### BACKGROUND

### (i) Technical Field

The present invention relates to a developing device and an image forming apparatus.

### (ii) Description of Related Art

Regarding an image forming apparatus in which an image of a developer on an image holding unit is electrostatically transferred and fixed to a medium such as paper so that image formation is performed, a technique described in JP2007-057896A ([0012] to [0021] and FIGS. 1 and 3) is known.

JP2007-057896A ([0012] to [0021] and FIGS. 1 and 3) describes a configuration in which a developer flow path regulating member (3) is disposed between an image carrier (1) and a developer carrier (2). The developer flow path regulating member (3) is disposed on a downstream side in a rotation direction of the developer carrier (2) with respect to a developing region (R). Therefore, the developer is stopped by the developer flow path regulating member (3), and a developer pool is formed in the developing region (R). A surface of the image carrier (1) is rubbed with a developer in the developer pool to remove discharge products.

### SUMMARY

Aspects of non-limiting embodiments of the present disclosure relate to a developing device and an image forming apparatus that improves a layer thickness of a second developer holding unit in a developing device including two developer holding units, at a position where developer is delivered from the first developer holding unit to the second developer holding unit, as compared with a case where an interval between a regulating unit and the second developer holding unit is longer than an interval between the regulating unit and the first developer holding unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device includes a first developer holding unit that is disposed to face an image holding unit, holds a developer on a surface thereof, and rotates to develop a latent image of the image holding unit, a second developer holding unit that is disposed downstream of the first developer holding unit in a rotation direction of the image holding unit, holds a developer on a surface thereof, and rotates to develop a latent image of the image holding unit, and a regulating unit that is disposed in a region in which the first developer holding unit and the second developer holding unit face each other and the developer is transferred from the first developer holding unit to the second developer holding unit and regulates a layer thickness of the developer held by the second developer holding unit, in which a closest distance between the regulating unit and the second developer holding unit is shorter than a closest distance between the regulating unit and the first developer holding unit.

### BRIEF DESCRIPTION OF THE DRAWINGS

Exemplary embodiment(s) of the present invention will be described in detail based on the following figures, wherein:

FIG. 1 is an overall explanatory view of an image forming apparatus of Example 1;

FIG. 2 is an enlarged explanatory view of a visible image forming apparatus of Example 1;

FIG. 3 is an explanatory view of a developing device of Example 1;

FIG. 4 is a cross-sectional view taken along line IV-IV of FIG. 3;

FIG. 5 is a cross-sectional view taken along line V-V in FIG. 3;

FIG. 6 is an enlarged view of a main part of a delivery region portion of developer;

FIGS. 7A and 7B are explanatory views of an action of Example 1, FIG. 7A is an explanatory view of a state where a regulating unit is disposed at a position close to a first developer holding unit, and FIG. 7B is an explanatory view of a state where the regulating unit is disposed at a position close to a second developer holding unit;

FIG. 8 is an explanatory view of a developing device of Example 2 and is a view corresponding to FIG. 6 of Example 1; and

FIG. 9 is an explanatory view of a developing device of Example 3 and is a view corresponding to FIG. 6 of Example 1.

### DETAILED DESCRIPTION

Next, a specific example (hereinafter, referred to as example) of an exemplary embodiment of the present invention will be described with reference to the drawings, but the present invention is not limited to examples to be described below.

In order to facilitate the understanding of the following description, in the drawings, a front-rear direction will be referred to as an X-axis direction, a right-left direction will be referred to as a Y-axis direction, and a vertical direction will be referred to as a Z-axis direction. Directions or sides indicated by arrows X, −X, Y, −Y, Z, and −Z will be defined as a forward direction, a rearward direction, a rightward direction, a leftward direction, an upward direction, and a downward direction, or a front side, a rear side, a right side, a left side, an upper side, and a lower side, respectively.

Further, in the drawings, a symbol “○” with a symbol “•” therein means an arrow from the back of the plane of the sheet to the front thereof and a symbol “○” with a symbol “×” therein means an arrow from the front of the plane of the sheet to the back thereof.

In the following description using the drawings, members other than members required for description will be appropriately omitted to facilitate understanding.

### Example 1

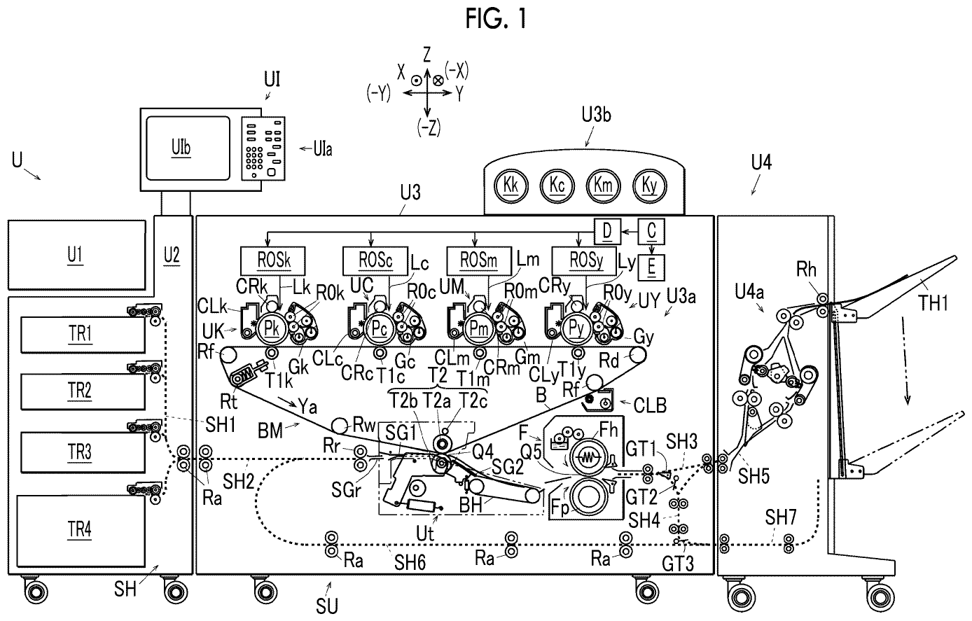

FIG. 1 is an overall explanatory view of an image forming apparatus of Example 1.

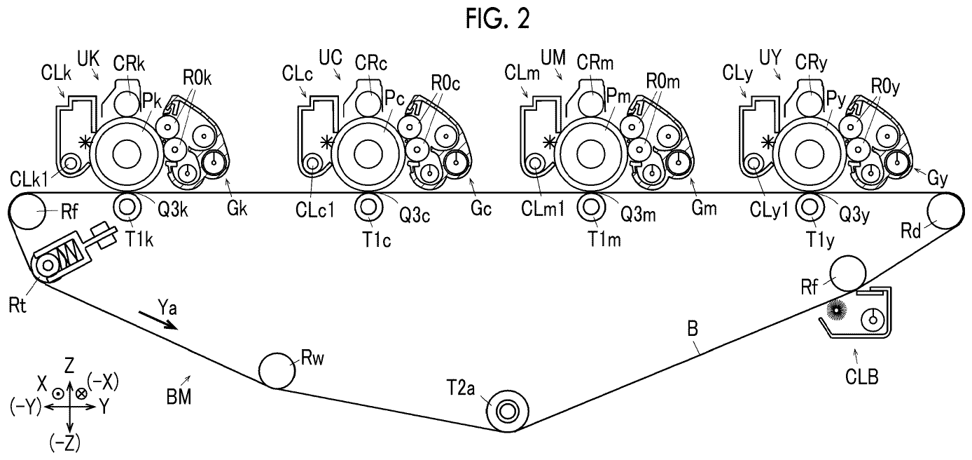

FIG. 2 is an enlarged explanatory view of a visible image forming apparatus of Example 1.

In FIG. 1, a copying machine U, which is an example of the image forming apparatus, includes a user interface UI which is an example of an operation unit, a scanner unit U1 which is an example of an image reading device, a feeder unit U2 which is an example of a medium supplying device, an image creating unit U3 which is an example of an image recording device, and a medium processing device U4.

### Description About User Interface UI

The user interface UI includes input buttons UIa used for the start of copying, the setting of the number of copies, or the like. Further, the user interface UI includes a display unit UIb that displays contents input via the input buttons UIa and a state of the copying machine U.

### Description about Feeder Unit U2

In FIG. 1, the feeder unit U2 includes a plurality of paper feed trays TR1, TR2, TR3, and TR4 which are examples of a medium accommodation container. In addition, the feeder unit U2 includes a medium supply path SH1 and the like through which a recording paper sheet S, which is an example of a medium for image recording and is accommodated in each of the paper feed trays TR1 to TR4, is transported to the image creating unit U3 after being extracted.

### Description about Image Creating Unit U3 and Medium Processing Device U4

In FIG. 1, the image creating unit U3 includes an image recording unit U3a that records an image on the recording paper sheet S transported from the feeder unit U2 based on a document image read by the scanner unit U1.

In FIGS. 1 and 2, a latent image forming device drive circuit D of the image creating unit U3 outputs, based on image information input from the scanner unit U1, a drive signal corresponding to the image information to latent image forming devices ROSy, ROSm, ROSc, and ROSk of yellow (Y), magenta (M), cyan (C), and black (K) at a time set in advance. Photoreceptor drums Py, Pm, Pc, and Pk which are examples of image holding units are respectively disposed below the latent image forming devices ROSy to ROSk which are examples of writing means.

Surfaces of the rotating photoreceptor drums Py to Pk are uniformly charged by charging rolls CRy, CRm, CRc, and CRk, which are examples of charging units, respectively. Via laser beams Ly, Lm, Lc, and Lk which are examples of latent image writing light output by the latent image forming devices ROSy to ROSk, electrostatic latent images are formed on the charged surfaces of the photoreceptor drums Py to Pk. The electrostatic latent images on the surfaces of the photoreceptor drums Py to Pk are developed into toner images, which are examples of yellow (Y), magenta (M), cyan (C), and black (K) visible images, by developing devices Gy, Gm, Gc, and Gk which are examples of developing units.

Regarding developer consumed due to development in the developing devices Gy to Gk, the developing devices Gy to Gk are replenished with developer from toner cartridges Ky, Km, Kc, and Kk which are examples of developer accommodating means. The toner cartridges Ky to Kk are attachably and detachably attached to a developer replenishment device U3b.

The toner images on the surfaces of the photoreceptor drums Py to Pk are sequentially transferred by primary transfer rolls T1y, T1m, T1c, and T1k, which are examples of primary transfer units and are examples of primary transfer devices, onto an intermediate transfer belt B, which is an example of an intermediate transfer unit, at primary transfer regions Q3y, Q3m, Q3c, and Q3k to be superimposed on each other. Accordingly, a color toner image which is an example of a multi-color visible image is formed on the intermediate transfer belt B. The color toner image formed on the intermediate transfer belt B is transported to a secondary transfer region Q4.

In addition, in a case where there is only image information for black, only the photoreceptor drum Pk and the developing device Gk for black are used, so that only a black toner image is formed.

Residues such as residual developer and paper dust adhering to the surfaces of the photoreceptor drums Py to Pk after primary transfer are removed by drum cleaners CLy, CLm, CLc, and CLk which are examples of cleaning units for image holding units.

In Example 1, the photoreceptor drum Pk, the charging roll CRk, and the drum cleaner CLk are integrated with each other as a photoreceptor unit UK for black, which is an example of an image holder unit. In addition, regarding the other colors which are yellow, magenta, and cyan as well, the photoreceptor drums Py, Pm, and Pc, the charging rolls CRy, CRm, and CRc, and the drum cleaners CLy, CLm, and CLc constitute photoreceptor units UY, UM, and UC.

In addition, the photoreceptor unit UK for black and the developing device Gk that includes a developing roll R0k, which is an example of a developer holding unit, constitute an image formation unit UK+Gk for black. Similarly, the photoreceptor units UY, UM, and UC for yellow, magenta, and cyan and the developing devices Gy, Gm, and Gc that include developing rolls R0y, R0m, and R0c constitute image formation units UY+Gy, UM+Gm, and UC+Gc for yellow, magenta, and cyan, respectively.

A belt module BM which is an example of an intermediate transfer unit is disposed below the photoreceptor drums Py to Pk. The belt module BM includes the intermediate transfer belt B which is an example of an image holding unit, a drive roll Rd which is an example of a drive unit for the intermediate transfer unit, a tension roll Rt which is an example of a tension applying unit, a walking roll Rw which is an example of meandering prevention unit, a plurality of idler rolls Rf which are examples of driven units, a backup roll T2a which is an example of a facing unit, and the primary transfer rolls T1y to T1k. The intermediate transfer belt B is supported to be rotatable and movable in a direction along an arrow Ya.

The primary transfer rolls T1y, T1m, and T1c for yellow, magenta, and cyan in Example 1 are supported to be able to approach to and separate from the photoreceptor drums Py, Pm, and Pc. In a case of multi-color printing (color printing), the primary transfer rolls T1y, T1m, and T1c for yellow, magenta, and cyan approach to the photoreceptor drums Py to Pc so that the intermediate transfer belt B is sandwiched by a contact pressure set in advance. Meanwhile, in a case of single-color printing (monochrome printing) for black only, the primary transfer rolls T1y, T1m, and T1c are separated from the photoreceptor drums Py to Pc.

A secondary transfer unit Ut is disposed below the backup roll T2a. The secondary transfer unit Ut includes a secondary transfer roll T2b which is an example of a secondary transfer member. A region where the secondary transfer roll T2b comes into contact with the intermediate transfer belt B forms the secondary transfer region Q4. In addition, the backup roll T2a faces the secondary transfer roll T2b with the intermediate transfer belt B interposed therebetween. The backup roll T2a is in contact with a contact roll T2c which is an example of an electric supply unit. A secondary transfer voltage of which the polarity is the same as toner charging polarity is applied to the contact roll T2c.

The backup roll T2a, the secondary transfer roll T2b, and the contact roll T2c constitute a secondary transfer device T2 which is an example of a secondary transfer unit.

The secondary transfer unit Ut of Example 1 is configured to be movable in a direction toward the intermediate transfer belt B and a direction away from the intermediate transfer belt B. The secondary transfer unit Ut moves in accordance with the type of the recording paper sheet S to be used, so that a contact pressure between the secondary transfer roll T2b and the intermediate transfer belt B is changed. For example, in a case where thick paper is used, it is possible to alleviate an impact caused in a case where a leading end of the thick paper enters the secondary transfer region Q4 by making the contact pressure low in comparison with a case where plain paper is used.

A medium transport path SH2 is disposed below the belt module BM. The recording paper sheet S fed from the medium supply path SH1 of the feeder unit U2 is transported by transport rolls Ra, which are examples of medium transport units, to a registration roll Rr which is an example of a transport timing adjustment unit. The registration roll Rr transports the recording paper sheet S to a downstream side in accordance with a time at which the toner image formed on the intermediate transfer belt B is transported to the secondary transfer region Q4. The recording paper sheet S sent by the registration roll Rr is guided by a paper sheet guide SGr on a registration side and a before-transfer paper sheet guide SG1, and is transported to the secondary transfer region Q4.

The toner image on the intermediate transfer belt B is transferred to the recording paper sheet S by the secondary transfer device T2 in a case where the toner image passes through the secondary transfer region Q4. In a case of a color toner image, toner images that are primarily transferred to be superimposed on the surface of the intermediate transfer belt B are collectively and secondarily transferred to the recording paper sheet S.

The primary transfer rolls T1y to T1k, the secondary transfer device T2, and the intermediate transfer belt B configure transfer apparatuses T1y to T1k+T2+B as examples of transfer units.

The intermediate transfer belt B after the secondary transfer is cleaned by a belt cleaner CLB which is an example of a cleaning unit for the intermediate transfer unit disposed downstream of the secondary transfer region Q4. The belt cleaner CLB removes, from the intermediate transfer belt B, residues such as developer and paper dust that remain without being transferred in the secondary transfer region Q4.

The recording paper sheet S on which the toner image has been transferred is guided by an after-transfer paper guide SG2 and is sent to a belt transport device BH which is an example of a medium transport unit. The belt transport device BH transports the recording paper sheet S to a fixing device F.

The fixing device F as an example of a fixing unit includes a heating roll Fh which is an example of a heating unit and a pressing roll Fp which is an example of a pressing unit. The recording paper sheet S is transported to a fixation region Q5, which is a region where the heating roll Fh and the pressing roll Fp come into contact with each other. In a case where the toner image on the recording paper sheet S passes through the fixation region Q5, the toner image is heated and pressed to be fixed by the fixing device F.

The image formation units UY+Gy to UK+Gk, the transfer apparatuses T1y to T1k+T2+B, and the fixing device F constitute an image recording unit U3a which is an example of an image formation unit of Example 1.

A switching gate GT1 which is an example of a switching unit is provided downstream of the fixing device F. The switching gate GT1 selectively switches the recording paper sheet S that has passed through the fixation region Q5 to any of a discharge path SH3 on the medium processing device U4 side or a reversal path SH4. The recording paper sheet S transported to the discharge path SH3 is transported to a paper sheet transport path SH5 of the medium processing device U4. A curl correction member U4a which is an example of a warp correction unit is disposed in the paper sheet transport path SH5. The curl correction member U4a corrects a warp (a so-called curl) of the recording paper sheet S transported into the curl correction member U4a. The recording paper sheet S, whose curl has been corrected, is discharged to a discharge tray TH1, which is an example of a medium discharge portion, by a discharge roll Rh, which is an example of a medium discharge member, with an image fixation surface of the paper sheet facing an upper side.

The recording paper sheet S that is caused to be transported toward the reversal path SH4 of the image creating unit U3 by the switching gate GT1 is transported to the reversal path SH4 of the image creating unit U3 through a second gate GT2 which is an example of the switching unit.

In a case where the recording paper sheet S is to be discharged with the image fixation surface facing a lower side, a transport direction of the recording paper sheet S is reversed after a trailing end of the recording paper sheet S in the transport direction passes through the second gate GT2. Here, the second gate GT2 of Example 1 is composed of a thin film-shaped elastic member. Therefore, the second gate GT2 allows the recording paper sheet S transported to the reversal path SH4 to pass through the second gate GT2 once and after the recording paper sheet S that has passed through the second gate GT2 is reversed and is, so to speak, switched back, the second gate GT2 guides the recording paper sheet S toward the transport paths SH3 and SH5. Then, the switched back recording paper sheet S passes through the curl correction member U4a and is discharged to the discharge tray TH1 with the image fixation surface facing the lower side.

A circulation path SH6 is connected to the reversal path SH4 of the image creating unit U3 and a third gate GT3 which is an example of a switching unit is disposed at the connection portion between the circulation path SH6 and the reversal path SH4. In addition, a downstream end of the reversal path SH4 is connected to a reversal path SH7 of the medium processing device U4.

The recording paper sheet S transported to the reversal path SH4 through the switching gate GT1 is caused by the third gate GT3 to be transported toward the reversal path SH7 of the medium processing device U4. As with the second gate GT2, the third gate GT3 of Example 1 is composed of a thin film-shaped elastic member. Therefore, the third gate GT3 allows the recording paper sheet S transported through the reversal path SH4 to pass through the third gate GT3 once and in a case where the recording paper sheet S that has passed through the third gate GT3 is switched back, the third gate GT3 guides the recording paper sheet S toward the circulation path SH6.

The recording paper sheet S transported to the circulation path SH6 is transported again to the secondary transfer region Q4 through the medium transport path SH2, and printing on the second surface is performed.

The elements denoted by the reference numerals “SH1” to “SH7” constitute a paper sheet transport path SH. In addition, the elements denoted by the reference numerals SH, Ra, Rr, Rh, SGr, SG1, SG2, BH, and GT1 to GT3 constitute a paper sheet transport device SU of Example 1.

### Description of Developing Device

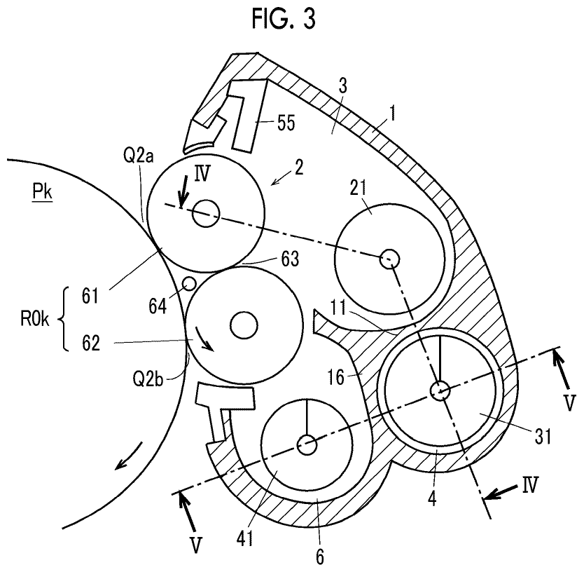

FIG. 3 is an explanatory view of a developing device of Example 1.

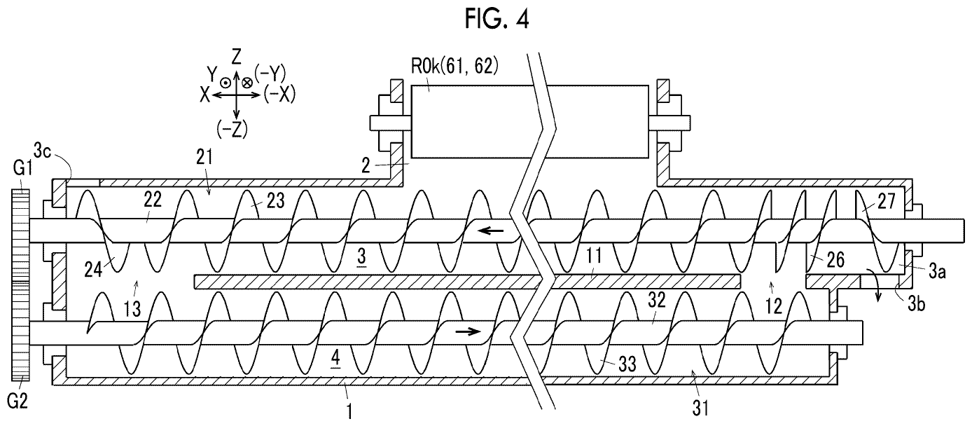

FIG. 4 is a cross-sectional view taken along line IV-IV of FIG. 3.

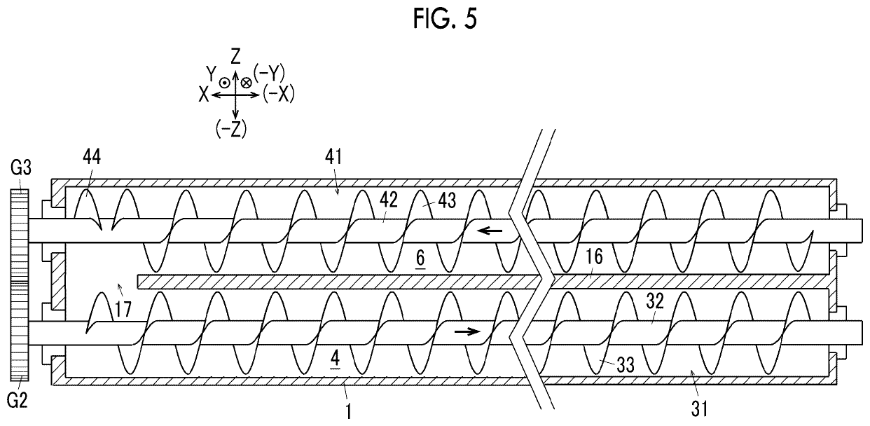

FIG. 5 is a cross-sectional view taken along line V-V in FIG. 3.

In the following description, since the developing devices Gy to Gk for yellow, magenta, and cyan are configured in the same manner, only the developing device Gk for black will be described, and the developing devices Gy, Gm, and Gc for the other colors will not be described.

In FIGS. 3 to 5, the developing devices Gy to Gk each have a developing container 1 as an example of an accommodating portion. In Example 1, the developing container 1 accommodates a two-component developer consisting of a negative charging toner and a positive charging magnetic carrier.

A developing chamber 2 in which the developing roll R0k is accommodated is formed inside the developing container 1. The developing chamber 2 extends along an axial direction of the developing roll R0k. A supply chamber 3, which is an example of first accommodating means, is formed adjacent to and in parallel with the developing chamber 2 on the right side.

In FIG. 4, a discharge chamber 3a extending in the rear side is formed at a rear end portion of the supply chamber 3. A discharge port 3b, which is an example of a discharge unit, is formed on a lower surface of a rear end of the discharge chamber 3a. In addition, a replenishing port 3c, which is an example of a fourth inflow unit, is formed on an upper surface of a front end portion of the supply chamber 3. A new developer from the toner cartridge Kk is replenished to the replenishing port 3c.

In FIGS. 3 to 5, a agitation chamber 4, which is an example of second accommodating means, is formed adjacent to and in parallel with the supply chamber 3. A return chamber 6, which is an example of third accommodating means, is formed adjacent to and in parallel with the developing chamber 2 and the agitation chamber 4. The developing chamber 2, the supply chamber 3, the agitation chamber 4, and the return chamber 6 accommodate a developer.

In FIGS. 3 and 4, the developing chamber 2 and the supply chamber 3 are connected to each other over the entire region of the developing roll R0k in the axial direction. That is, a partitioning unit that prevents the inflow of developer is not provided between the developing chamber 2 and the supply chamber 3. The supply chamber 3 and the agitation chamber 4 are partitioned by a first partition wall 11 which is an example of a first partitioning unit. A first inflow portion 12, which is an example of a first inflow unit, is formed on a rear end side of the first partition wall 11. A second inflow portion 13, which is an example of a second inflow unit, is formed on a front end side of the first partition wall 11. The developer is capable of flowing between the supply chamber 3 and the agitation chamber 4 through the first inflow portion 12 and the second inflow portion 13.

In FIGS. 3 and 5, the agitation chamber 4 and the return chamber 6 are partitioned by a second partition wall 16 which is an example of a second partitioning unit. A third inflow portion 17, which is an example of a third inflow unit, is formed on a front end side of the second partition wall 16. No inflow unit is provided on a rear end side of the second partition wall 16. Therefore, the developer is capable of flowing between the agitation chamber 4 and the return chamber 6 through the third inflow portion 17. In Example 1, the developing chamber 2 and the return chamber 6 are connected over the entire region of the developing roll R0k in the axial direction. Therefore, the developer is capable of flowing in the entire region in the axial direction between the developing chamber 2 and the return chamber 6.

A supply auger 21, which is an example of a first transport unit, is accommodated in the supply chamber 3. The supply auger 21 has a first rotary shaft 22. Both end portions of the first rotary shaft 22 are rotatably supported by the developing container 1. A first gear G1, which is an example of a driven unit, is supported by one outer end portion of the first rotary shaft 22.

A first main transport blade 23, which is an example of a main transport portion, is supported by the first rotary shaft 22. In Example 1, the first main transport blade 23 is configured as a spiral blade having a predetermined winding direction. In a case where the first rotary shaft 22 rotates, the first main transport blade 23 transports the developer in the supply chamber 3 from the rear side to the front side. That is, the first main transport blade 23 transports the developer from the first inflow portion 12 toward the second inflow portion 13.

At a front end portion of the first rotary shaft 22, a first reverse transport blade 24 is supported at a position in front of the first main transport blade 23. The first reverse transport blade 24 is configured as a spiral blade having a winding direction opposite to the winding direction of the first main transport blade 23. Therefore, in a case where the first rotary shaft 22 rotates, the first reverse transport blade 24 transports the developer in the supply chamber 3 toward the rear side. The first reverse transport blade 24 applies a transport force in a reverse direction to the developer transported forward by the first main transport blade 23 to suppress the movement of the developer to the front side and to promote the flow of the developer to the agitation chamber 4 through the second inflow portion 13.

At a rear portion of the first rotary shaft 22, a first sub transport blade 26 is supported at a position on a rear side of the first main transport blade 23. The first sub transport blade 26 is formed as a spiral having the same winding direction as the first main transport blade 23, and having a spiral pitch (a distance advanced in the axial direction during one rotation in the circumferential direction of the first rotary shaft 22) smaller than the spiral pitch of the first main transport blade 23. Therefore, in a case where the first rotary shaft 22 rotates, the first sub transport blade 26 transports the developer in the supply chamber 3 forward with a transport force weaker than the transport force of the first main transport blade 23. Therefore, a part of the developer flowing into the supply chamber 3 through the first inflow portion 12 flows past the first main transport blade 23 and flows into the rear discharge chamber 3a.

At the rear end portion of the first rotary shaft 22, a discharge transport blade 27 is supported at a position on the rear side of the first sub transport blade 26. The discharge transport blade 27 is configured as a spiral blade in a direction opposite to the winding direction of the first main transport blade 23. Therefore, in a case where the first rotary shaft 22 rotates, the discharge transport blade 27 transports the developer in the supply chamber 3, particularly, in the discharge chamber 3a toward the rear discharge port 3b.

An agitation auger 31, which is an example of a second transport unit, is accommodated in the agitation chamber 4. The agitation auger 31 has a second rotary shaft 32. Both end portions of the second rotary shaft 32 are rotatably supported by the developing container 1. A second gear G2, which is an example of a driven unit, is supported by one outer end portion of the second rotary shaft 32. In Example 1, the second gear G2 meshes with the first gear G1.

A second main transport blade 33, which is an example of the main transport portion, is supported by the second rotary shaft 32. In Example 1, the second main transport blade 33 is configured as a spiral blade having the same winding direction as the first main transport blade 23. In a case where the second rotary shaft 32 rotates, the second main transport blade 33 transports the developer in the agitation chamber 4 from the front side to the rear side. That is, the second main transport blade 33 transports the developer from the second inflow portion 13 toward the first inflow portion 12.

A return auger 41, which is an example of a third transport unit, is accommodated in the return chamber 6. The return auger 41 has a third rotary shaft 42. Both end portions of the third rotary shaft 42 are rotatably supported by the developing container 1. A third gear G3, which is an example of the driven unit, is supported by one outer end portion of the third rotary shaft 42. In Example 1, the third gear G3 meshes with the second gear G2.

The third main transport blade 43, which is an example of the main transport portion, is supported by the third rotary shaft 42. In Example 1, the third main transport blade 43 is configured as a spiral blade having the same winding direction as the first main transport blade 23. In a case where the third rotary shaft 42 rotates, the third main transport blade 43 transports the developer in the return chamber 6 from the rear side to the front side. That is, the third main transport blade 43 transports the developer in the return chamber 6 toward the third inflow portion 17.

At a front end portion of the third rotary shaft 42, a third reverse transport blade 44 is supported at a position in front of the third main transport blade 43. The third reverse transport blade 44 is configured as a spiral blade having a winding direction opposite to the winding direction of the third main transport blade 43. Therefore, in a case where the third rotary shaft 42 rotates, the third reverse transport blade 44 applies a force for transporting the developer in the return chamber 6 rearward. The third reverse transport blade 44 applies a transport force in a reverse direction to the developer transported forward by the third main transport blade 43 to suppress the movement of the developer to the front side and to promote the flow of the developer to the agitation chamber 4 through the third inflow portion 17.

Therefore, the developer in the agitation chamber 4 of the developing container 1 is transported rearward while being agitated by the rotation of the agitation auger 31. The developer transported to a rear end of the agitation chamber 4 flows into the supply chamber 3 through the first inflow portion 12. The developer in the supply chamber 3 is transported from the rear side to the front side while being agitated by the rotation of the supply auger 21. At this time, a part of the developer in the supply chamber 3 is supplied to the developing roll R0k. The developer transported to a front end of the supply chamber 3 flows into the agitation chamber 4 through the second inflow portion 13. Therefore, the developer circulates through the supply chamber 3 and the agitation chamber 4.

The developer that is supplied to the developing roll R0k but is not used for developing is returned to the return chamber 6. The developer in the return chamber 6 is transported forward while being agitated by the return auger 41. The developer transported to a front end of the return chamber 6 flows into the agitation chamber 4 through the third inflow portion 17. Therefore, the developer returned from the developing roll R0k also circulates and is reused.

In a case where the developer is consumed as the development proceeds, a new developer is supplied through the replenishing port 3c. The new developer supplied from the replenishing port 3c flows into the agitation chamber 4 through the second inflow portion 13 from the front end of the supply chamber 3. The developer is transported while being agitated in the agitation chamber 4 by the agitation auger 31 and is used for development.

A part of the developer that has flowed into the discharge chamber 3a is discharged from the discharge port 3b. By gradually discharging the developer in the developing container 1 from the discharge port 3b while replenishing new developer from the replenishing port 3c, it is possible to gradually replace the deteriorated developer.

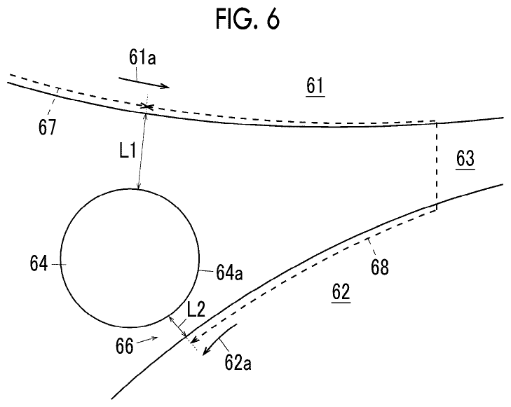

FIG. 6 is an enlarged view of a main part of a delivery region portion of developer.

The developing roll R0k is disposed in the developing chamber 2. The developing roll Rk of Example 1 has a first developing roll 61, which is an example of a first developer holding unit, and a second developing roll 62, which is an example of a second developer holding unit. The first developing roll 61 and the second developing roll 62 are used in a case where the configurations and the diameters are the same, but the first developing roll 61 and the second developing roll 62 having different diameters can also be used.

The first developing roll 61 forms a first developing region Q2a in a region facing the photoreceptor drum Pk. Further, the second developing roll 62 forms a second developing region Q2b in a region facing the photoreceptor drum Pk. Therefore, the latent image on the surface of the photoreceptor drum Pk is developed in the first developing region Q2a on an upstream side and the second developing region Q2b on a downstream side.

Further, a delivery region 63, which is a region to which the developer is transferred from the first developing roll 61 to the second developing roll 62, is formed in a region where the first developing roll 61 and the second developing roll 62 face each other.

In the first developing roll 61, a rotation direction 61a is set to be the forward direction (with direction) with respect to the movement direction of the surface of the photoreceptor drum Pk in the first developing region Q2a. In the second developing roll 62, a rotation direction 62a is set to be the forward direction (with direction) with respect to the movement direction of the surface of the photoreceptor drum Pk in the second developing region Q2b. Therefore, in the delivery region 63, the movement direction of the surface of the first developing roll 61 and the movement direction of the surface of the second developing roll 62 are in a reverse direction (against direction).

A regulating bar 64, which is an example of a regulating unit, is disposed at a position on the upstream side in the rotation direction of the first developing roll 61, that is, on the downstream side in the rotation direction of the second developing roll 62, with respect to the delivery region 63. The regulating bar 64 is disposed at a position where a closest distance L2 to the second developing roll 62 is shorter than a closest distance L1 to the first developing roll 61.

The regulating bar 64 of Example 1 can be made of any material, but is, for example, desirably made of a material capable of frictionally charging the developer to a negative polarity in a case of being rubbed against the developer. That is, the regulating bar 64 is, for example, desirably made of a material having a charging ability of the same polarity as the charging polarity of the developer (negative polarity in Example 1). In a case where the developer is frictionally charged to the negative polarity being rubbed against the regulating bar 64, the charging potential of the developer can be increased even in a case where the charging potential decreases by passing through the first developing region Q2a or the like. In a case where the charging potential decreases, the developer becomes less likely to be held on the photoreceptor drum Pk and the second developing roll 62, causing the developer to float, which leads to the phenomenon known as toner cloud. In a case where the material having the charging ability of the same polarity as the charging polarity of the developer is used for the regulating bar 64 as in Example 1, the occurrence of the toner cloud is suppressed.

The regulating bar 64 of Example 1 is configured as a cylindrical or rod-shaped member. Therefore, with respect to the rotation direction 62a of the second developing roll 62, as moving downstream from the delivery region 63 toward a closest position 66, an opposing surface 64a of the regulating bar 64 shortens the distance to the surface of the second developing roll 62. Therefore, in a case where the distance becomes longer, it is possible to regulate a layer thickness of the developer with the regulating bar 64 at the closest position 66.

A layer thickness of the first developing roll 61 is regulated by a first trimmer 55 disposed in the developing chamber 2.

### Action of Example 1

In the developing device Gk of Example 1 including the above configuration, the latent image on the surface of the photoreceptor drum Pk is developed by the two developing rolls 61 and 62. Therefore, compared to a configuration with a single developing roll, the developing device Gk can cope even in a case where the rotation speed of the photoreceptor drum Pk increases.

The developer held on the surface of the first developing roll 61 after the developer has been consumed in the first developing region Q2a is delivered to the second developing roll 62. Therefore, the amount of developer delivered from the first developing roll 61 to the second developing roll 62 varies. In particular, in a case where the amount of the developer consumed in the first developing region Q2a is small, the amount of the developer reaching the delivery region 63 increases. Therefore, the amount of the developer held on the surface of the second developing roll 62 also increases. Therefore, the thickness (layer thickness) of the developer held by the second developing roll 62 may become excessively thick. In a case where the layer thickness of the developer becomes excessively thick, there is a risk that development defects such as an overly dense developed image and the toner cloud may occur.

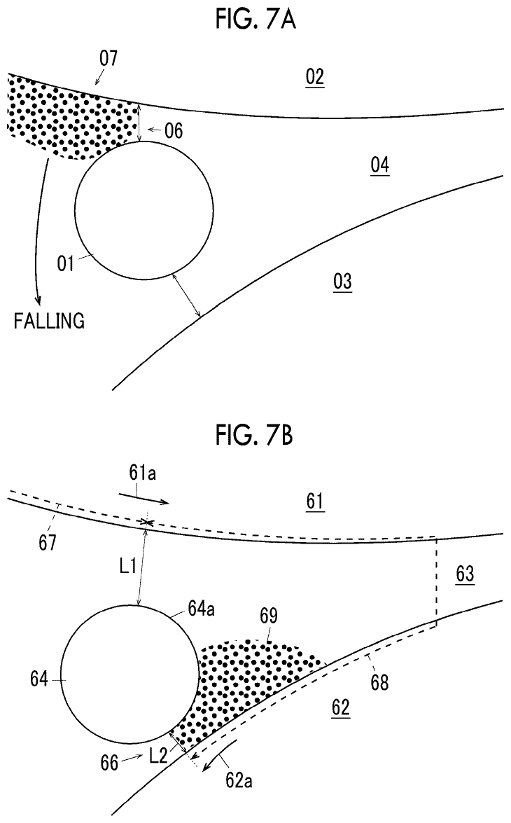

FIGS. 7A and 7B are explanatory views of an action of Example 1, FIG. 7A is an explanatory view of a state where a regulating unit is disposed at a position close to a first developer holding unit, and FIG. 7B is an explanatory view of a state where the regulating unit is disposed at a position close to a second developer holding unit.

In FIG. 7A, in a case where the closest distance between a regulating bar 01 and a first developing roll 02 is shorter than the closest distance between the regulating bar 01 and a second developing roll 03, the developer flowing into a delivery region 04 is more likely to be regulated. That is, the developer is likely to be stopped by the regulating bar 01 in an upstream region 07 in the rotation direction of the first developing roll 02 with respect to a closest position 06 between the regulating bar 01 and the first developing roll 02. Therefore, the developer stopped in the upstream region 07 may float and cause the toner cloud. In addition, in a case where the amount of the stopped developer is excessive, the developer may fall due to gravity and fall on the second developing roll 03. In a case where the developer falls on the second developing roll 03, the layer thickness of the developer held by the second developing roll 03 becomes locally excessive, which causes a cause of development defect.

On the other hand, in Example 1, as shown in FIG. 7B, the closest distance L2 between the regulating bar 64 and the second developing roll 62 is shorter. Therefore, the developer is less likely to be stopped in an upstream region 67 as compared with the configuration of FIG. 7A. In addition, the developer is likely to accumulate in an intermediate region 68, which is a region from the delivery region 63 to the closest position 66, as compared with the configuration of FIG. 7A. That is, a developer pool 69 is likely to be generated. Therefore, even in a case where the amount of the developer held by the first developing roll 61 and reaching the delivery region 63 increases, the amount of the developer is regulated by the regulating bar 64, and the layer thickness of the developer sent to the second developing region Q2b is suppressed from being excessively thick. In addition, in a case where the amount of developer sent from the first developing roll 61 to the delivery region 63 is small, the layer thickness of the developer sent to the second developing region Q2b is suppressed from being too small in a manner that a part of the developer accumulated in the developer pool 69 in the intermediate region 68 is replenished. In addition, in a case where the developer pool 69 is generated, pressure acts on the developer passing through between the regulating bar 64 and the second developing roll 62. The pressure reaches an equilibrium state in a case where the amount of the developer pool 69 is equal to or more than a certain level. In a case where the equilibrium state is reached, the layer thickness of the developer passing through between the regulating bar 64 and the second developing roll 62 is particularly likely to be stable. For example, it is also preferable to operate (so-called idling) the developing device Gk before image formation to form the developer pool 69 in advance.

Therefore, in the developing device Gk having the two developing rolls 61 and 62, the layer thickness of the second developing roll 62 is improved as compared with a case where an interval (closest distance L2) between the regulating bar 64 and the second developing roll 62 is longer than an interval (closest distance L1) between the regulating bar 64 and the first developing roll 61 at a position (upstream region 67 to intermediate region 68) where the developer is delivered from the first developing roll 61 to the second developing roll 62.

### Example 2

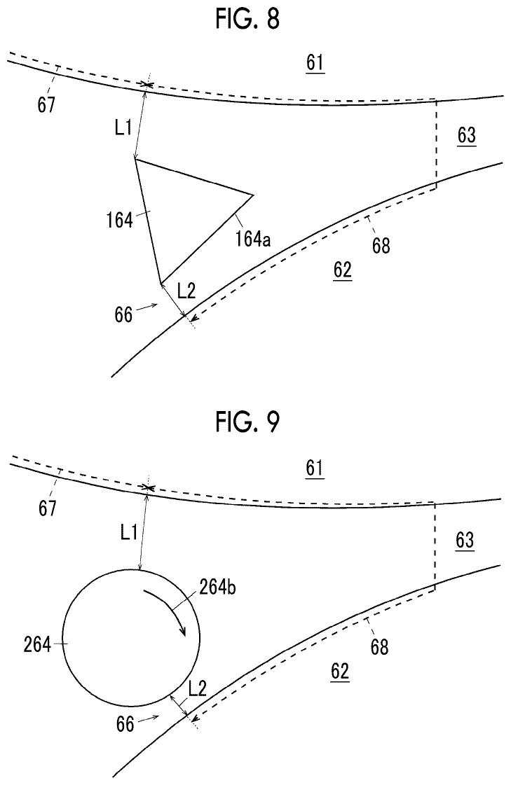

FIG. 8 is an explanatory view of a developing device of Example 2 and is a view corresponding to FIG. 6 of Example 1.

In the description of Example 2, the constituent elements corresponding to the constituent elements of Example 1 are designated by the same reference numerals, and detailed description thereof will be omitted.

Example 2 is different from the above Example 1 in the following points, but is configured similar to the above Example 1 in other points.

In FIG. 8, in the developing device Gk of Example 2, a regulating member 164, which is an example of a regulating unit, is disposed instead of the regulating bar 64 of Example 1. The cross-sectional shape of the regulating member 164 of Example 2 is formed in a wedge shape. Similar to Example 1, the regulating member 164 of Example 2 is disposed at a position where the closest distance L2 between the regulating member 164 and the second developing roll 62 is shorter than the closest distance L1 between the regulating member 164 and the first developing roll 61. In addition, in the regulating member 164 of Example 2, with respect to the rotation direction 62a of the second developing roll 62, as moving downstream from the delivery region 63 toward a closest position 66, an opposing surface 164a of the regulating member 164 is disposed to shorten the distance to the surface of the second developing roll 62.

### Action of Example 2

In the developing device Gk of Example 2 including the above configuration, a developer pool is generated between the closest position 66 and the delivery region 63 by the wedge-shaped regulating member 164. Therefore, the layer thickness of the second developing roll 62 is improved.

### Example 3

FIG. 9 is an explanatory view of a developing device of Example 3 and is a view corresponding to FIG. 6 of Example 1.

In the description of Example 3, the constituent elements corresponding to the constituent elements of Example 1 are designated by the same reference numerals, and detailed description thereof will be omitted.

Example 3 is different from the above Example 1 in the following points, but is configured similar to the above Example 1 in other points.

In FIG. 9, in the developing device Gk of Example 3, a regulating bar 264 is rotatably supported instead of the non-rotatable regulating bar 64 of Example 1.

The regulating bar 264 of Example 3 is rotated by receiving drive transmitted from a motor (not shown). A rotation direction 264b of the regulating bar 264 is set such that the movement direction of the portion facing the first developing roll 61 is in the forward direction with respect to the movement direction of the surface of the first developing roll 61, and the movement direction of the portion facing the second developing roll 62 is also in the forward direction with respect to the movement direction of the surface of the second developing roll 62.

In addition, a peripheral speed of rotation of the regulating bar 264 of Example 3 is set to be smaller than a peripheral speed of rotation of the first developing roll 61 and to be smaller than a peripheral speed of rotation of the second developing roll 62.

### Action of Example 3

In the developing device of Example 3 including the configuration, the regulating bar 264 rotates. In the non-rotatable regulating bar 64 of Example 1, the developer may adhere to the regulating bar 64 over time and form a solidified mass. In a case where the solidified mass is peeled off from the regulating bar 64 and is sent to the second developing region Q2b, the mass becomes a cause of development defect. On the other hand, in Example 3, in a case where the regulating bar 264 rotates, the developer is unlikely to adhere to the regulating bar 264, and the adhered developer is likely to be peeled off before the developer adhered to the regulating bar 264 becomes a large solidified mass. In particular, in Example 3, the regulating bar 264 is rotated at a rotation speed at which a peripheral speed difference occurs with respect to the second developing roll 62. Therefore, the developer adhered to the regulating bar 264 is likely to receive a frictional force from the developer of the developer pool, and the developer is unlikely to grow into a large solidified mass. Therefore, the occurrence of development defects caused by the solidified mass of the developer is suppressed.

In addition, the regulating bar 264 of Example 3 rotates in the forward direction with respect to the second developing roll 62. Therefore, excessive load and stress applied to the developer of the developer pool are suppressed. As a result, the deterioration of the developer is reduced, and the occurrence of development defects is suppressed.

### MODIFICATION EXAMPLES

The examples of the present invention have been described in detail above, but the present invention is not limited to the examples described above and can have various modifications without departing from the scope of the present invention described in claims. Modification Examples (H01) to (H06) of the present invention are exemplified below.

(H01) In the above examples, the copying machine U which is an example of the image forming apparatus has been described. However, the present invention is not limited thereto and application to a fax machine or application to a multifunction machine having a plurality of functions of a fax machine, a printer, a copying machine, and the like is also possible. In addition, the present invention is not limited to a multi-color development image forming apparatus and a monochromatic image forming apparatus, that is, a so-called monochrome image forming apparatus may also be adopted. Furthermore, the present invention is not limited to the image forming apparatus, and the present invention can also be applied to any electronic device or mechanical device in which a motor and gears are used.

(H02) In the above examples, the intermediate transfer belt B has been described as an example of an image holding unit. However, the present invention is not limited thereto and application to a photoreceptor or the like is also possible. Therefore, the image holding unit is not limited to a belt-shaped member and application to a drum-shaped member is also possible.

(H03) In the above examples, the rotation directions of the first developing roll 61 and the second developing roll 62 are preferably the rotation direction exemplified in the examples, but is not limited thereto. The rotation direction of either one or both of the first developing roll 61 and the second developing roll 62 may be set to the reverse direction.

(H04) In the above examples, a rod-shaped or a wedge-shaped form has been described as an example of the regulating unit, but the present invention is not limited thereto. For example, the shape may be any polygonal shape such as a rectangular prism or a hexagonal prism, a plate shape, a film shape, or the like.

(H05) In the above Example 3, the rotation direction of the regulating bar 264 is, for example, preferably set to rotate in the forward direction with respect to the second developing roll 62, but may also be in the reverse direction.

(H06) In the above Example 3, the rotation speed of the regulating bar 264 is exemplified as causing a peripheral speed difference with respect to the second developing roll 62 (the peripheral speed ratio is 1 or less). However, the present invention is not limited thereto. The peripheral speed of the regulating bar 264 may be set to be the same as the peripheral speed of the second developing roll 62 (peripheral speed difference zero, peripheral speed ratio 1), or the regulating bar 264 may be rotated such that the peripheral speed ratio with respect to the second developing roll 62 is greater than 1.

### SUPPLEMENTARY NOTE

(((1)))

A developing device comprising:
a first developer holding unit that is disposed to face an image holding unit, holds a developer on a surface thereof, and rotates to develop a latent image of the image holding unit;
a second developer holding unit that is disposed downstream of the first developer holding unit in a rotation direction of the image holding unit, holds a developer on a surface thereof, and rotates to develop a latent image of the image holding unit; and
a regulating unit that is disposed in a region in which the first developer holding unit and the second developer holding unit face each other and the developer is transferred from the first developer holding unit to the second developer holding unit and regulates a layer thickness of the developer held by the second developer holding unit,
wherein a closest distance between the regulating unit and the second developer holding unit is shorter than a closest distance between the regulating unit and the first developer holding unit.
(((2)))

The developing device according to (((1))),
wherein the developing device comprises the regulating unit configured with a material having a charging ability of the same polarity as a charging polarity of the developer.
(((3)))

The developing device according to (((1))) or (((2))),
wherein the developing device comprises the first developer holding unit that rotates such that a surface thereof moves in a forward direction with respect to a movement direction of a surface of the image holding unit, in a first developing region that is a facing region with the image holding unit, and
the second developer holding unit that rotates such that a surface thereof moves in a forward direction with respect to the movement direction of the surface of the image holding unit, in a second developing region that is a facing region with the image holding unit.
(((4)))

The developing device according to any one of (((1))) to (((3))),
wherein the regulating unit has a surface facing the second developer holding unit, and a distance between the surface and the surface of the second developer holding unit becomes shorter toward a downstream side along a rotation direction of the second developer holding unit.
(((5)))

The developing device according to (((4))),
wherein the developing device comprises the regulating unit having a cross-sectional shape formed in a wedge shape.
(((6)))

The developing device according to any one of (((1))) to (((4))),
wherein the developing device comprises the regulating unit that is rotatably supported.
(((7)))

The developing device according to (((6))),
wherein in a rotation direction of the regulating unit, a movement direction of a portion facing the first developer holding unit is a forward direction with respect to a movement direction of the surface of the first developer holding unit, and a movement direction of a portion facing the second developer holding unit is a forward direction with respect to the surface of the second developer holding unit.
(((8)))

The developing device according to (((6))) or (((7))),
wherein a peripheral speed of rotation of the regulating unit is smaller than a peripheral speed of rotation of the first developer holding unit and is smaller than a peripheral speed of rotation of the second developer holding unit.
(((9)))

An image forming apparatus comprising:
an image holding unit;
the developing device according to any one of (((1))) to (((8))) that develops an image of the image holding unit;
a transfer unit that transfers the image developed by the developing device from the image holding unit to a medium; and
a fixing device that fixes the image transferred to the medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a first developer holding unit that is disposed to face an image holding unit, holds a developer on a surface thereof, and rotates to develop a latent image of the image holding unit;
a second developer holding unit that is disposed downstream of the first developer holding unit in a rotation direction of the image holding unit, holds a developer on a surface thereof, and rotates to develop a latent image of the image holding unit; and
a regulating unit that is disposed in a region in which the first developer holding unit and the second developer holding unit face each other and the developer is transferred from the first developer holding unit to the second developer holding unit and regulates a layer thickness of the developer held by the second developer holding unit,
wherein a closest distance between the regulating unit and the second developer holding unit is shorter than a closest distance between the regulating unit and the first developer holding unit.

2. The developing device according to claim 1,
wherein the developing device comprises the regulating unit configured with a material having a charging ability of the same polarity as a charging polarity of the developer.

3. The developing device according to claim 1,
wherein the developing device comprises the first developer holding unit that rotates such that a surface thereof moves in a forward direction with respect to a movement direction of a surface of the image holding unit, in a first developing region that is a facing region with the image holding unit, and
the second developer holding unit that rotates such that a surface thereof moves in a forward direction with respect to the movement direction of the surface of the image holding unit, in a second developing region that is a facing region with the image holding unit.

4. The developing device according to claim 1,
wherein the regulating unit has a surface facing the second developer holding unit, and a distance between the surface and the surface of the second developer holding unit becomes shorter toward a downstream side along a rotation direction of the second developer holding unit.

5. The developing device according to claim 4,
wherein the developing device comprises the regulating unit having a cross-sectional shape formed in a wedge shape.

6. The developing device according to claim 1,
wherein the developing device comprises the regulating unit that is rotatably supported.

7. The developing device according to claim 6,
wherein in a rotation direction of the regulating unit, a movement direction of a portion facing the first developer holding unit is a forward direction with respect to a movement direction of the surface of the first developer holding unit, and a movement direction of a portion facing the second developer holding unit is a forward direction with respect to the surface of the second developer holding unit.

8. The developing device according to claim 6,
wherein a peripheral speed of rotation of the regulating unit is smaller than a peripheral speed of rotation of the first developer holding unit and is smaller than a peripheral speed of rotation of the second developer holding unit.

9. An image forming apparatus comprising:
an image holding unit;
the developing device according to claim 1 that develops an image of the image holding unit;
a transfer unit that transfers the image developed by the developing device from the image holding unit to a medium; and
a fixing device that fixes the image transferred to the medium.

10. An image forming apparatus comprising:
an image holding unit;
the developing device according to claim 2 that develops an image of the image holding unit;
a transfer unit that transfers the image developed by the developing device from the image holding unit to a medium; and
a fixing device that fixes the image transferred to the medium.

11. An image forming apparatus comprising:
an image holding unit;
the developing device according to claim 3 that develops an image of the image holding unit;
a transfer unit that transfers the image developed by the developing device from the image holding unit to a medium; and
a fixing device that fixes the image transferred to the medium.

12. An image forming apparatus comprising:
an image holding unit;
the developing device according to claim 4 that develops an image of the image holding unit;
a transfer unit that transfers the image developed by the developing device from the image holding unit to a medium; and
a fixing device that fixes the image transferred to the medium.

13. An image forming apparatus comprising:
an image holding unit;
the developing device according to claim 5 that develops an image of the image holding unit;
a transfer unit that transfers the image developed by the developing device from the image holding unit to a medium; and
a fixing device that fixes the image transferred to the medium.

14. An image forming apparatus comprising:
an image holding unit;
the developing device according to claim 6 that develops an image of the image holding unit;
a transfer unit that transfers the image developed by the developing device from the image holding unit to a medium; and
a fixing device that fixes the image transferred to the medium.

15. An image forming apparatus comprising:
an image holding unit;
the developing device according to claim 7 that develops an image of the image holding unit;
a transfer unit that transfers the image developed by the developing device from the image holding unit to a medium; and
a fixing device that fixes the image transferred to the medium.

16. An image forming apparatus comprising:
an image holding unit;
the developing device according to claim 8 that develops an image of the image holding unit;
a transfer unit that transfers the image developed by the developing device from the image holding unit to a medium; and
a fixing device that fixes the image transferred to the medium.

17. A developing device comprising:
a first developer holding means that is disposed to face an image holding means, for holding a developer on a surface thereof, and rotates to develop a latent image of the image holding means;
a second developer holding means that is disposed downstream of the first developer holding means in a rotation direction of the image holding means, for holding a developer on a surface thereof, and rotating to develop a latent image of the image holding means; and
a regulating means that is disposed in a region in which the first developer holding means and the second developer holding means face each other and the developer is transferred from the first developer holding means to the second developer holding means, for regulating a layer thickness of the developer held by the second developer holding means,
wherein a closest distance between the regulating means and the second developer holding means is shorter than a closest distance between the regulating means and the first developer holding means.
